(19) United States
(12) Patent Application Publication
(10) Pub. No.: US 2010/0245545 A1
(43) Pub. Date: Sep. 30, 2010

(54) Flagging of Z-Space for a Multi-Camera 3D Event

(76) Inventor: Melanie Ilich-Toay, Castaic, CA (US)

Correspondence Address: Stattler-Suh PC, 60 SOUTH MARKET, SUITE 480, SAN JOSE, CA, 95113, US

(21) Appl. No.: 12/750,461

(22) Filed: Mar. 30, 2010

Related U.S. Application Data
(60) Provisional application No. 61/211,401, filed on Mar. 30, 2009.

(51) Int. Cl. H04N 13/02; G06K 9/00

(52) U.S. Cl. 348/47; 382/154; 348/E13.074

(57) ABSTRACT

A method for selecting one from among a plurality of three-dimensional (3D) cameras comprising calculating, in a computer, a plurality of z-space cut zone flag values corresponding to the plurality of 3D cameras, then comparing the z-space cut zone flag corresponding to a reference monitor image to a plurality of candidate z-space cut zone flags corresponding to candidate monitor images. In response to the results of the calculations and comparisons, a safe/not-safe indication is prepared for displaying on any of a variety of visual displays, at least one aspect of the safe/not-safe indication, the at least one aspect determined in response to said comparing. The method uses 3D camera image data, 3D camera positional data and 3D camera stage data (e.g. interaxial data, convergence data, lens data) for encoding the 3D camera data into an encoded data frame which is then transmitted to a processor for producing a visual safe/not-safe indication.

This application claims priority, under 35 U.S.C. §119(e), to U.S. Provisional Application No. 61/211,401 filed Mar. 30, 2009, which is expressly incorporated herein by reference.

### FIELD OF THE INVENTION

The present invention generally relates to three-dimensional imaging, and more particularly to managing three-dimensional video editing events.

### BACKGROUND

Video editing or film editing using two-dimensional rendering has long been the province of creative people such as videographers, film editors, and directors. Movement through a scene might involve wide shots, panning, zooming, tight shots, etc and any of those in any sequence. With the advent of three-dimensional (3D) cameras have come additional complexities. An image in a three-dimensional rendering appears as a 3D image only because of slight differences between two images. In other words, a three-dimensional rendering appears as a 3D image when a left view is slightly different from a right view. The range of the slight differences is limited inasmuch as, when viewed by the human eye, the viewer's brain is ‘tricked’ into perceiving a three-dimensional image from two two-dimensional images.

When video editing or film editing uses three-dimensional rendering, movement through a scene might involve wide shots, panning, zooming, tight shots, and any of such shots; however, unlike the wide range of possible editing sequences in two dimensions, only certain editing sequences in three dimensions result in pleasing and continuous perception by the human viewer of a three-dimensional scene. Some situations, such as broadcasting live events, demands that editing sequences in three dimensions be decided in real time, possibly involving a large number of three-dimensional cameras, each 3D camera producing a different shot of the overall scene. Such a situation presents a very large number of editing possibilities, only some of which are suitable for producing a pleasing and continuous perception by the human viewer of a three-dimensional scene. Thus, live editing of three-dimensional coverage of an event presents a daunting decision-making task to videographers, technical directors, directors, and the like.

Accordingly, there exists a need for flagging editing possibilities which are suitable for producing continuous perception by the human viewer of a three-dimensional scene.

### SUMMARY OF THE INVENTION

A method for selecting one from among a plurality of three-dimensional (3D) cameras comprising calculating, in a computer, a plurality of z-space cut zone flag values corresponding to the plurality of 3D cameras, then comparing the z-space cut zone flag corresponding to a reference monitor image to a plurality of candidate z-space cut zone flags corresponding to candidate monitor images. In response to the results of the calculations and comparisons, a safe/not-safe indication is prepared for displaying on any of a variety of visual displays, at least one aspect of the safe/not-safe indication, the at least one aspect determined in response to said comparing. The method uses 3D camera image data, 3D camera positional data and 3D camera stage data (e.g. interaxial data, convergence data, lens data) for encoding the 3D camera data into an encoded data frame which is then transmitted to a processor for producing a visual safe/not-safe indication.

Various apparatus are claimed, the claimed apparatus serving for implementing the method. A general purpose processor/computer with software can be used to implement the method, thus a computer program product in the form of a computer readable medium for storing software instructions is also claimed.

### BRIEF DESCRIPTION OF THE DRAWINGS

A brief description of the drawings follows:

FIG. 1A depicts a juxtaposition of camera and a subject within a scene for rendering in 3D where the subject point of interest is situated roughly at the intersection of the ray lines of each 2D camera, according to one embodiment.

FIG. 1B depicts a juxtaposition of camera and a subject within a scene for rendering in 3D where the point of interest is situated farther from the 2D cameras than the intersection of the ray lines of each 2D camera, according to one embodiment.

FIG. 1C depicts a juxtaposition of camera and a subject within a scene for rendering in 3D where the point of interest is situated closer to the 2D cameras than the intersection of the ray lines of each 2D camera, according to one embodiment.

FIG. 2 depicts a director's wall system comprising an array of 2D monitors, which might be arranged into an array of any number of rows and columns, according to one embodiment.

FIG. 3 depicts geometries of a system used in determining the quantities used in z-space flagging, according to one embodiment.

FIG. 4 depicts an encoding technique in a system for encoding metadata together with image data for a 3D camera, according to one embodiment.

FIG. 5 depicts a system showing two 2D cameras (left view 2D camera and right view 2D camera) in combination to form a 3D camera, according to one embodiment.

FIG. 6 depicts an architecture of a system for flagging of z-space for a multi-camera 3D event comprising several modules, according to one embodiment.

FIG. 7 depicts a schematic of a lens having a ray aberration that introduces different focal lengths depending on the incidence of the ray on the lens, according to one embodiment.

FIG. 8 depicts a flowchart of a method for flagging of z-space for a multi-camera 3D event, according to one embodiment.

FIG. 9 depicts a flow chart of a method for selecting one from among a plurality of three-dimensional (3D) cameras, according to one embodiment.

FIG. 10 depicts a block diagram of a system to perform certain functions of an apparatus for selecting one from among a plurality of three-dimensional (3D) cameras, according to one embodiment.

FIG. 11 is a diagrammatic representation of a network including nodes for client computer systems, nodes for server computer systems and nodes for network infrastructure, according to one embodiment.

### DETAILED DESCRIPTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by those skilled in the art.

Unless the context clearly requires otherwise, throughout the description and the claims, the words “comprise”, “comprising” and the like are to be construed in an inclusive sense as opposed to an exclusive or exhaustive sense; that is to say, in a sense of “including, but not limited to”. Words using the singular or plural number also include the plural or singular number, respectively. Additionally, the words “herein”, “above”, “below”, and words of similar import, when used in this application, shall refer to this application as a whole and not to any particular portion(s) of this application.

The detailed description of embodiments of the invention is not intended to be exhaustive or to limit the invention to the precise form disclosed above. While specific embodiments of, and examples for, the invention are described herein for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only to the systems described herein. The various embodiments described herein can be combined to provide further embodiments. These and other changes can be made to the invention in light of the detailed description.

Aspects of the invention can be modified, if necessary, to employ the systems, functions and concepts of the various patents and applications described above to provide yet further embodiments of the invention.

These and other changes can be made to the invention in light of this detailed description.

### Overview

When video editing or film editing uses three-dimensional rendering, movement through a scene might involve wide shots, panning, zooming, tight shots, and any of such shots; however, unlike the wide range of possible editing sequences in two dimensions, only certain editing sequences in three dimensions result in pleasing and continuous perception by the human viewer of a three-dimensional scene. Some situations, such as broadcasting live events, demands that editing sequences in three dimensions be decided in real time, possibly involving a large number of three-dimensional cameras, each 3D camera producing a different shot of the overall scene. Such situation presents a very large number of editing possibilities, only some of which are suitable for producing a pleasing and continuous perception by the human viewer of a three-dimensional scene. Thus, live editing of three-dimensional coverage of, for instance, a live event presents a daunting decision-making task to the videographers, technical directors, directors and the like.

One such editing possibility that can be made computer-assisted or even fully automated is the flagging of z-space coordinates.

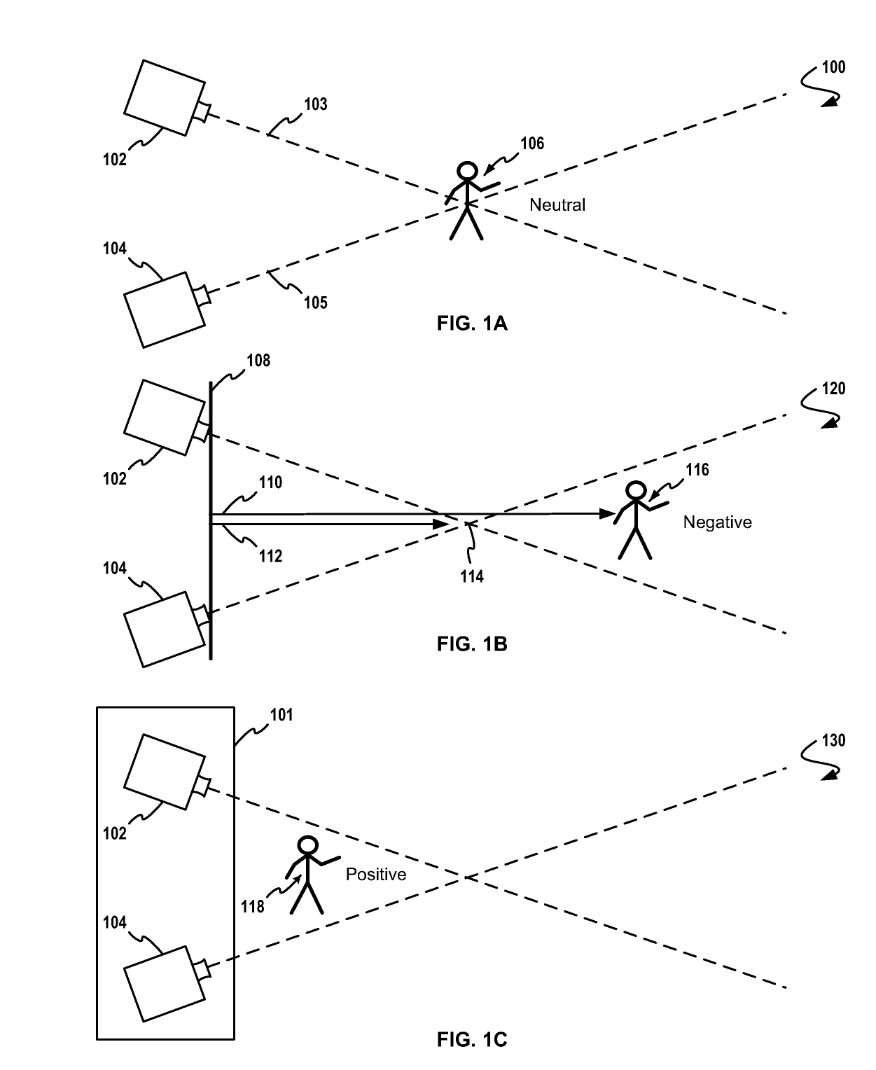

FIG. 1A depicts a juxtaposition of camera and a subject within a scene of a system 100 for rendering in 3D where the subject point of interest 106 is situated roughly at the intersection of the ray lines of each 2D camera. As shown, there is a left ray line 103 emanating from a left view 2D camera 102, the left ray line being collinear with a line tangent to the lens of a left view 2D camera 102. Similarly, there is a right ray line 105 emanating from a right view 2D camera 104, the right ray line being collinear with a line tangent to the lens of a right view 2D camera 104. In the example of FIG. 1A, the intersection of the left ray line 103 and the right ray line 105 is substantially at the same position as the subject point of interest 106. More formally, the scene can be considered in three dimensions, each dimension denoted as x-space, y-space, and z-space. The x-space dimension may be considered to be a range of left/right coordinates characterizing a width dimension, the y-space dimension may be considered to be a range of down/up coordinates characterizing a height dimension, and the z-space dimension may be considered to be a range of near/far coordinates characterizing a distance dimension.

A situation whereby the intersection of the left ray line 103 and the right ray line 105 is substantially at the same position as the subject point of interest 106 is known as ‘z-space neutral’. Using the same scene, and using the same 2D cameras in the same position, but where the closer subject point of interest 116 has moved closer to the 2D cameras is known as ‘z-space positive’. Also, using the same scene, and using the same 2D cameras in the same position, but where the farther subject point of interest 118 has moved farther from the 2D cameras is known as a ‘z-space negative’.

FIG. 1B depicts a juxtaposition of camera and a subject within a scene of a system 120 for rendering in 3D where the point of interest is situated farther from the 2D cameras than the intersection of the ray lines of each 2D camera. As shown, there is an imaginary line representing an imaginary z equal zero plane 108 from which plane z-space distances in the scene might be measured, and a quantity z_{flag} may be calculated using a distance to intersection 112 and a distance to point of interest 110 as:

z_{flag}=(distance to intersection)−(distance to point of interest) (EQ. 1)

For example, if the distance from the z equal zero plane 108 to the intersection 114 is measured to be quantity Z₀, and the distance from the z equal zero plane 108 to the farther point of interest 116 is measured to be quantity Z₀,+alpha (alpha being greater than zero), then the difference can be calculated as:

z_{flag}=(Z₀)−(Z₀,+alpha) (EQ. 2)

z_{flag}=−alpha (EQ. 3)

Thus, in the example of FIG. 1B, the quantity z_{flag} is a negative numeric value, and the juxtaposition is z-space negative.

FIG. 1C depicts a juxtaposition of camera and a subject within a scene of a system 130 for rendering in 3D where the point of interest is situated closer to the 2D cameras than the intersection of the ray lines of each 2D camera. This situation is known as z-space positive, and is calculated using the measurements and operations of EQ. 2.

As earlier indicated, certain edits (transitions) between 3D shots are pleasing and are considered suitable for producing continuous perception by the human viewer of a three-dimensional scene. A policy for transitions based on the values of z_{flag} are shown in Table 1.

TABLE 1
Permitted From→To transitions based on z_{flag}

| Negative | Neutral | Positive | Policy | |
|---|---|---|---|---|
| z_{flag} | z_{flag} | z_{flag} | Statement | Comment |
| From | To | | Permitted | Continuous transition |
| | From | To | Permitted | Continuous transition |
| To | | From | Permitted | Continuous transition |
| From | | To | Not permitted | Discontinuous transition |
| To | | From | Not permitted | Discontinuous transition |

Thus, such a table may be used in a system for calculating z_{flag}, corresponding to a From→To transition to provide visual aids to videographers, technical directors, directors, editors, and the like to make decisions to cut or switch between shots. The permitted/not-permitted (safe/not-safe) indication derives from comparing the first z-space cut zone flag corresponding to a reference monitor image to at least one of a plurality of candidate z-space cut zone flags corresponding to candidate monitor images, then using a table of permitted (or safe/not-safe) transitions. Of course the Table 1 above is merely one example of a table-based technique for calculating z_{flag}, corresponding to a From→To transition, and other policies suitable for representation in a table are reasonable and envisioned.

This solution will help technical directors, directors, editors, and the like make real-time edit decisions to cut or switch a live broadcast or live-to-tape show using legacy 2D equipment. However, using 2D equipment to make edit decisions for a live 3D broadcast has no fail-safe mode, and often multiple engineers are required in order to evaluate To→From shots. One approach to evaluating To→From shots (for ensuring quality control of the live 3D camera feeds), is to view a 3D signal on a 3D monitor; however, broadcasting companies have spent many millions of dollars upgrading their systems in broadcast studios and trucks for high definition (HD) broadcast, and are reluctant to retro-fit again with 3D monitors. Still, the current generation of broadcast trucks are capable of handling 3D video signals, thus, the herein disclosed 3D z-space flagging can be incorporated as an add-on software interface or an add-on component upgrade, thus extending the useful lifespan of legacy 2D video components and systems.

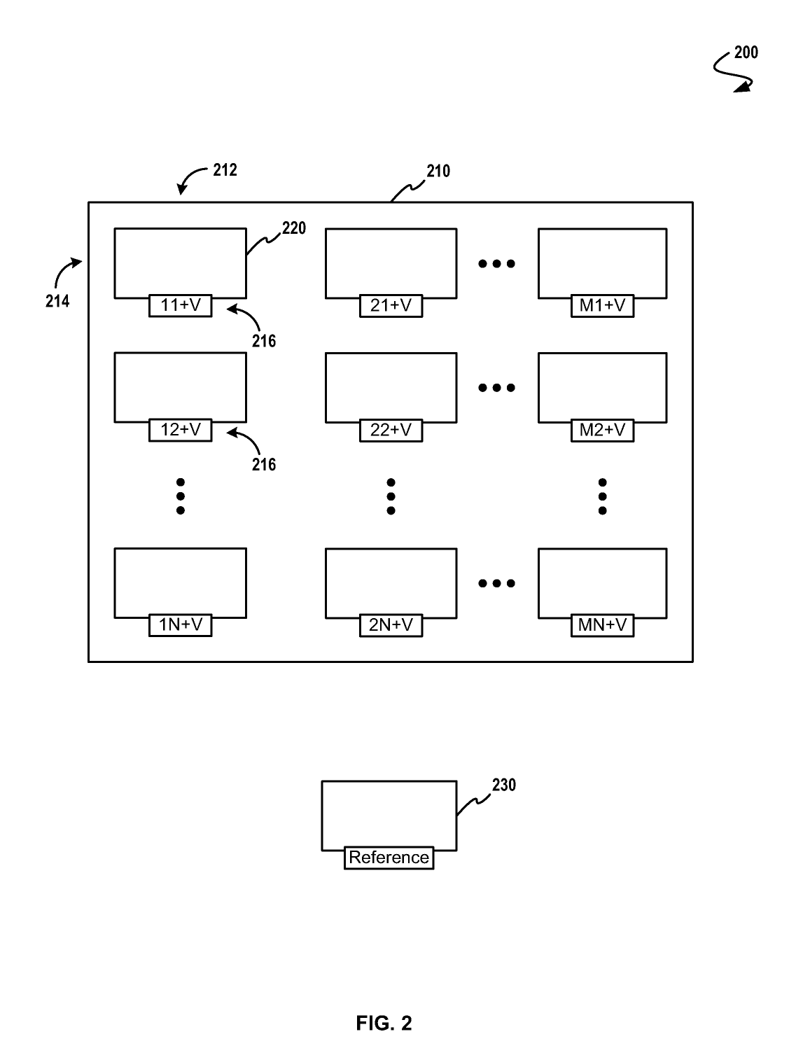

FIG. 2 depicts a director's wall system 200 comprising an array of 2D monitors 210, which might be arranged into an array 210 of any number of rows 214 and columns 212. Also shown is a “live” monitor shown as a reference monitor 230, which might be assigned to carry the live (broadcasted) feed. In this embodiment, the z-space flagging might be indicated using a z-space flag indicator 216, which might be any visual indicator associated with a paired 2D monitor 210. A visual indication on a director's wall system 200 might be provided using a z-space flag indicator 216 in the form of a visual indicator separate from the 2D monitor (e.g. a pilot light, an LCD screen, etc), or it might be in the form of a visual indicator integrated into the 2D monitor, or even it might be in the form of a visual indicator using some characteristic of the 2D monitor (e.g. using a color or a shading or a pattern or a back light, or an overlay, or a visual indication in any vertical blanking area, etc).

In operation, a director might view the reference monitor 230 and take notice of any of the possible feeds in the array 210, also taking note of the corresponding z-space flag indicator 216. The director might then further consider as candidates only those possible feeds in the array 210 that also indicates an acceptable From→To transition, using the z-space flag indicator 216 for the corresponding candidate.

### Z-Space Measurements, Calibration and Calculations

One way to assign numeric values to the quantities in EQ. 2 is to take advantage of the known geometries used in a 3D camera configuration. A 3D camera configuration 101 is comprised of two image sensors (e.g. a left view 2D camera 102 and a right view 2D camera 104). The geometry of the juxtaposition of the two image sensors can be measured in real time. In exemplary cases, a left view 2D camera 102 and a right view 2D camera 104 are each mounted onto a mechanical stage, and the mechanical stage is controllable by one or more servo motors, which positions and motions are measured by a plurality of motion and positional measurement devices. More particularly, the stage mechanics, servo motors, and measurement devices are organized and interrelated so as to provide convergence, interaxial, and lens data of the 3D camera configuration 101.

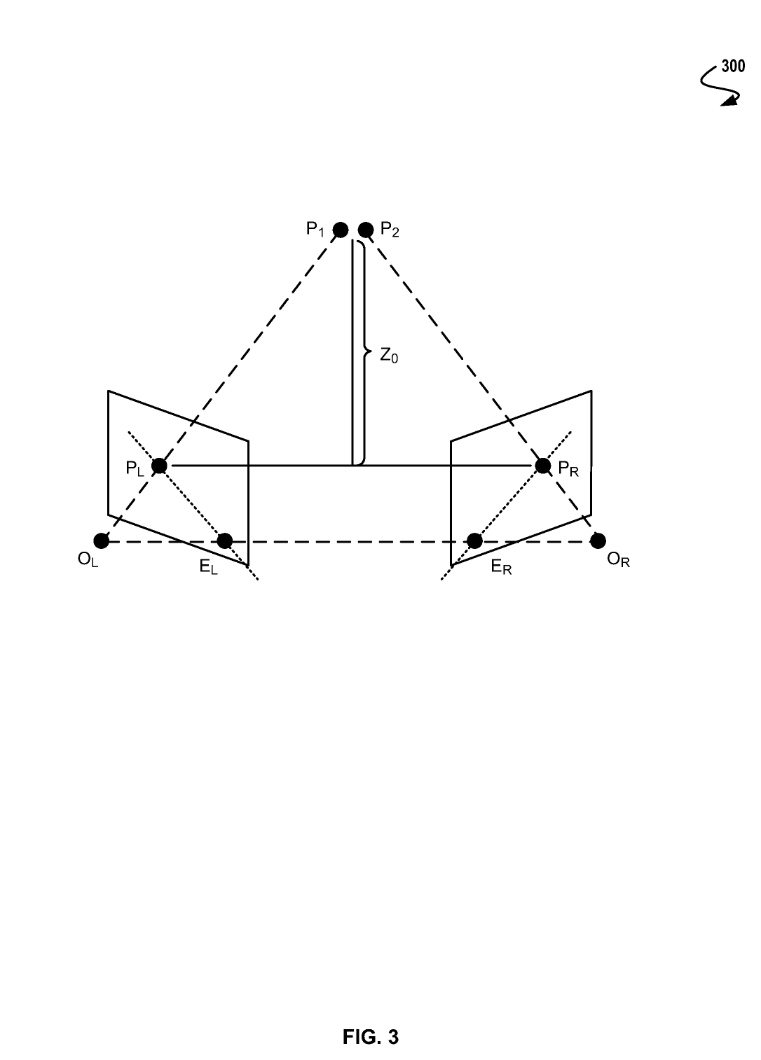

FIG. 3 depicts geometries of a system 300 used in determining the quantities used in z-space flagging. The figure is a schematic of the aforementioned stage and image sensors. Conceptually, a left view image sensor (not shown) is mounted at point O_{L}, and another sensor, a right view image sensor (not shown) is mounted at point O_{R}. The distance between point O_{L} and O_{R} (e.g. interaxial distance) can be known at any time. The angle between the segment O_{L}-O_{R} and the segment O_{L}-P₁ can be known at any time. Similarly, the angle between the segment O_{L}-O_{R} and the segment O_{R}-P₂ can also be known at any time. Of course the aforementioned points P₁ and P₂ are purely exemplary, and may or may not coincide between any two image sensors. Nevertheless, in a typical 3D situation, each image sensor is focused on the same subject, so the points P₁ and P₂ are often close together. Now, considering the geometric case when P₁ is in fact identical with P₂, the system 300 depicts a triangle with vertices O_{L}, O_{R}, P₁. And, as just described, the base and two angles are known; thus, all vertex positions and angles can be known. The segment P_{L}-P_{R} lies on the z equal zero plane 108, and forms a similar triangle with vertices P_{L}, P_{R}, and P₁. Accordingly, one implication is that an estimate of the quantity z₀ (a distance) can be calculated with an accuracy proportional to the distance from the camera to the subject of interest. Given a good estimate of the quantity z₀ (a distance) the quantity z₀ can be used in EQ. 2 allowing the value of z_{flag} to be calculated and used in conjunction with a z-space flag indicator 216 in order to provide a visual indication to videographers, film editors, directors, and the like.

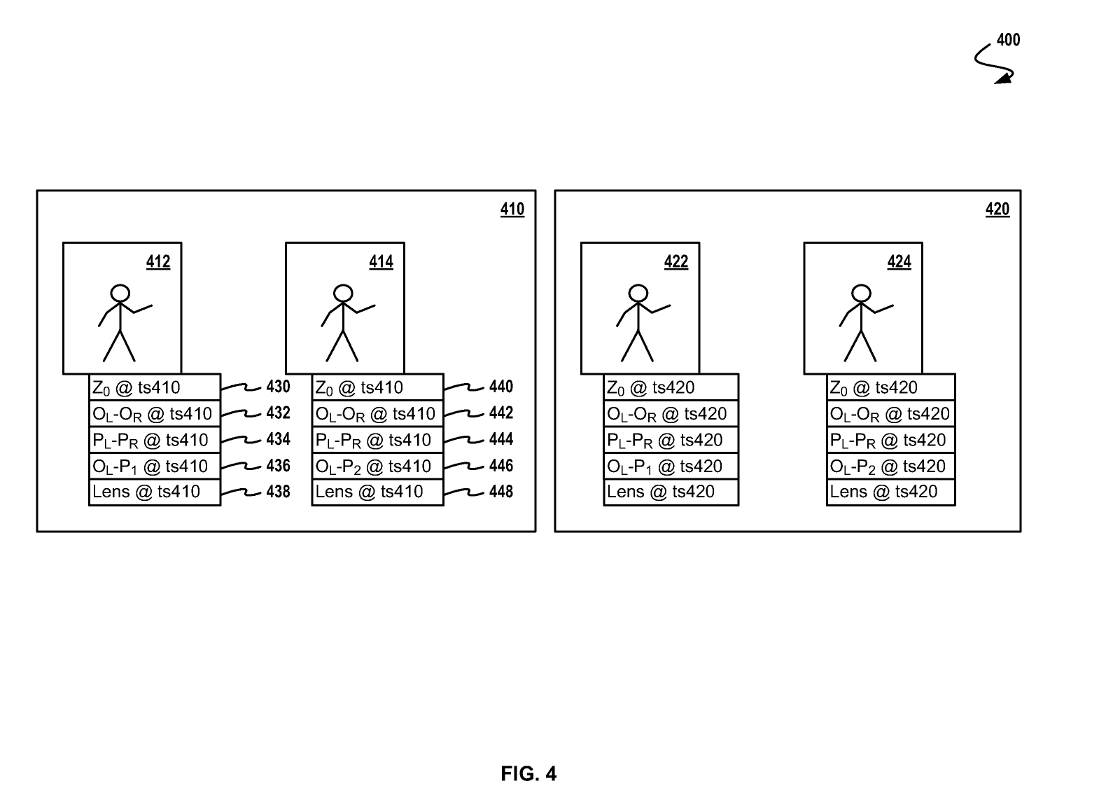

FIG. 4 depicts an encoding technique in a system 400 for encoding metadata together with image data for a 3D camera. As shown, a first 3D frame 410 might be comprised of data representing two 2D images, one each from a left view 2D camera and another from a right view 2D camera, namely left view 2D data 412 and right view 2D data 414. A next 3D frame 420 might be similarly composed, and might comprise left image data 422 and right image data 424 at some next timestep (denoted “ts”). Metadata might be encoded and attached or co-located or synchronized with, or otherwise correlated, to a 2D image. As shown, the metadata corresponding to the left view 2D data 412 image is labeled as z-distance data 430 (e.g. Z₀ at ts410), interaxial data 432 (e.g. O_{L}−O_{R} at ts410), Z-reference data 434 (e.g. P_{L}−P_{R} at ts410), actual distance data 436 (e.g. O_{L}−P₁ at ts410), and lens data 438 (e.g. Lens at ts410). Similarly, the metadata corresponding to the right view 2D data 414 image is labeled as Z₀ at ts410 440, O_{L}−O_{R} at ts410 442, P_{L}−P_{R} at ts410 444, O_{L}−P₂ at ts410 446, and Lens at ts410 448.

Those skilled in the art will recognize that differences in the quantities correspond to various physical quantities and interpretations. Table 2 shows some such interpretations.

TABLE 2
Interpretations of metadata used to calculate z_{flag}

| Difference | Small Difference | Large Difference |
|---|---|---|
| Z₀ at ts410 430 vs | Normal | Out of calibration lens |
| Z₀ at ts410 440 | | data sensors or wrong |
| | | focal convergence |
| O_{L}-O_{R} at ts410 432 vs | Normal within | Malfunctioning interaxial |
| O_{L}-O_{R} at ts410 442 | tolerances | sensor or communications |
| P_{L}-P_{R} at ts410 434 vs | Normal within | Malfunctioning interaxial |
| P_{L}-P_{R} at ts410 444 | tolerances | sensor or communications |
| O_{L}-P₁ at ts410 436 vs | Normal | Out of calibration lens |
| O_{L}-P₂ at ts410 446 | | data sensors or wrong |
| | | focal convergence |

Now, it can be seen that by encoding the metadata (e.g. convergence data, interaxial data, and lens data) from the 3D camera system, and embedding it into the video stream, the metadata can be decoded to determine and indicate the z-space flag between multiple cameras, thus facilitating quick editorial decisions. In this embodiment, the z-space flag may be mathematically calculated frame by frame using computer-implemented techniques for performing such calculations. Thus, flagging of z-space in a 3D broadcast solution (using multiple 3D camera events) can be done using the aforementioned techniques and apparatus that processes the camera video/image streams with the camera metadata feeds and automatically selects via back light, overlay, or other means which camera's 3D feed will edit correctly (mathematically) with the current cut/program camera (picture). In other terms, matching z-space cameras are automatically flagged in real time by a computer processor (with software) to let the videographers, technical directors, directors etc know which cameras are “safe” to cut to.

In some embodiments, the metadata might be encoded with an error code (e.g. using a negative value) meaning that there is an error detected in or by the camera or in or by the sensors; in which such error code case, the corresponding candidate monitor images are removed from the candidate set in response to a corresponding 3D camera error code and, in which such error code case, there might be an indication using the corresponding z-space flag indicator 216.

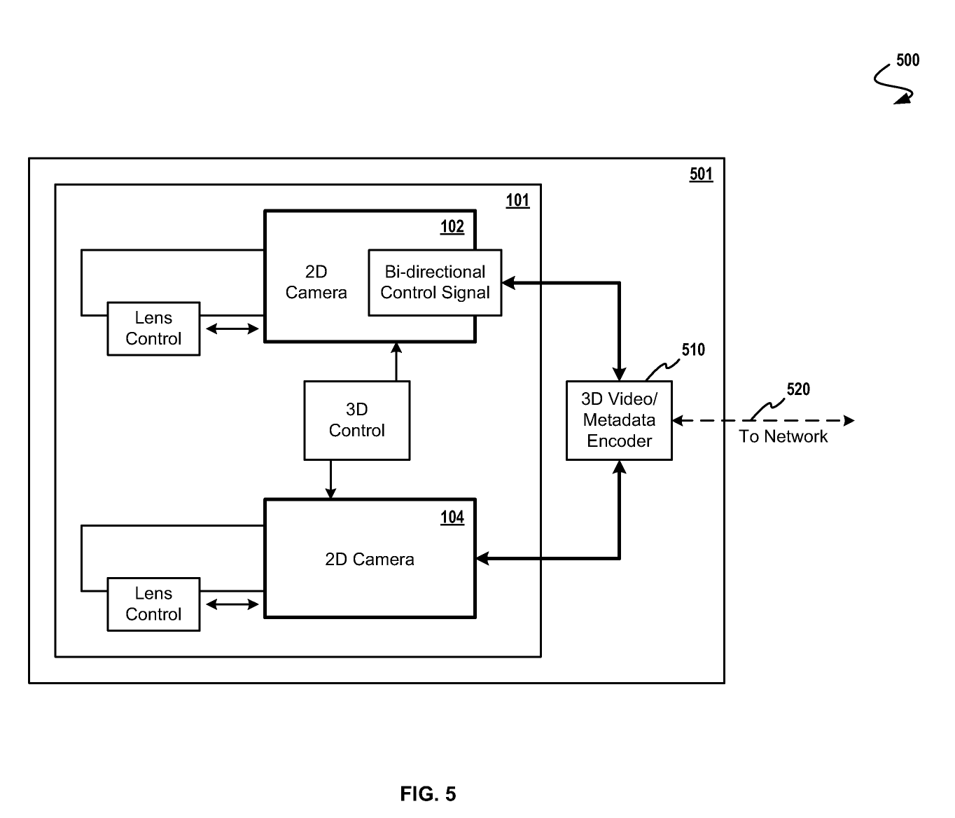

FIG. 5 depicts a system 500 showing two 2D cameras (a left view 2D camera 102 and a right view 2D camera 104) in combination to form a 3D camera configuration 101. Also shown are various control elements for controlling servos and making distance and angle measurements in real time. The 3D video and metadata encoder 510 serves to assemble image data together with metadata. In exemplary embodiments, image data streams (frame by frame) from the image sensors, and the metadata streams (frame by frame) from the various sensors. Further, the 3D video and metadata encoder 510 serves to assemble (e.g. stream, packetize) the combined image data and metadata for communication over a network 520 (e.g. over a LAN or WAN), possibly using industry-standard communication protocols and apparatus (e.g. Ethernet over copper, Ethernet over fiber, Fibre Channel, etc.). Thus the data from any given 3D camera can be sent at high data rates over long distances.

### Embodiments of a Computer-Based System

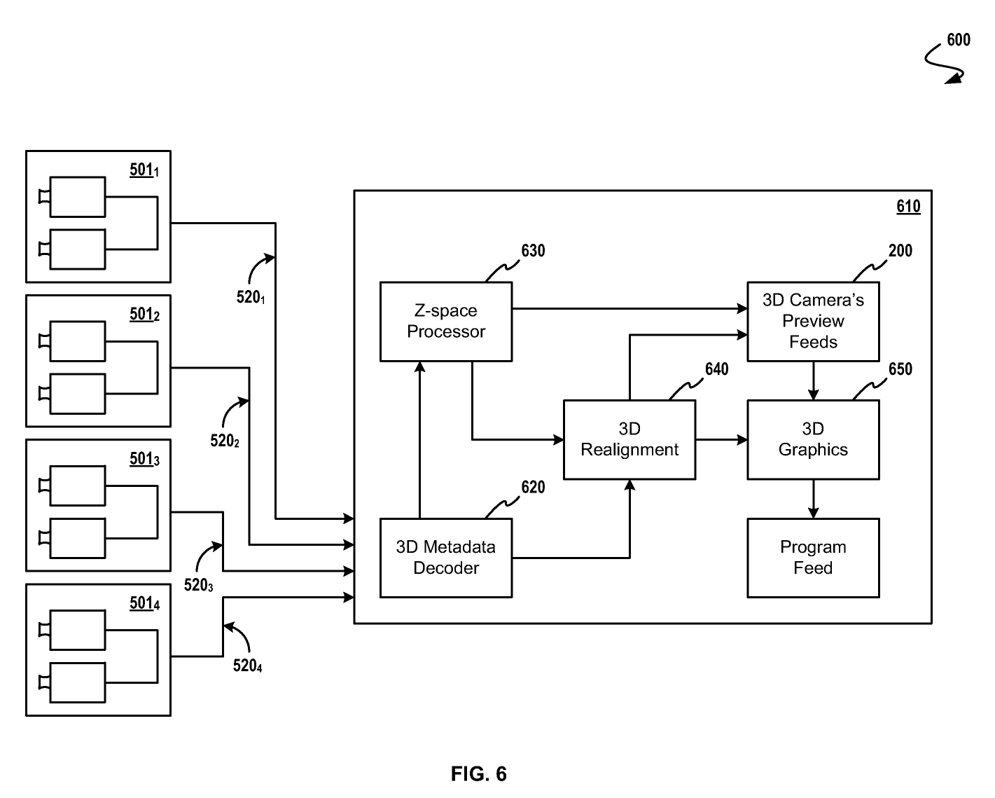

FIG. 6 depicts an architecture of a system 600 for flagging of z-space for a multi-camera 3D event comprising several modules. As shown, the system is partitioned into an array of 3D cameras (e.g. 3D camera 501₁, 501₂, 501₃, 501₄, etc) in communication over a network (e.g. over physical or virtual circuits including paths 520₁, 520₂,520₃, 520₄, etc.) to a z-space processing subsystem 610, which in turn is organized into various functional blocks.

In some embodiments, the streaming data communicated over the network is received by the z-space processing subsystem 610 and is at first processed by a 3D metadata decoder 620. The function of the decoder is to identify and extract the metadata values (e.g. as Z₀ at ts410 430, O_{L}−O_{R} at ts410 432, P_{L}−P_{R} at ts410 434, O_{L}−P₁ at ts410 436) and preprocess the data items into a format usable by the z-space processor 630. The z-space processor then may apply the aforementioned geometric model to the metadata. That is, by taking the encoded lens data (e.g. O_{L}−P₁ at a particular timestep) from the camera and sending it to the z-space processor 630, the processor can determine if the subject (i.e. by virtue of the lens data) is a near (foreground) or a far (background) subject. The z-space processor 630 might further cross-reference the lens data with the convergence and interaxial data from that camera to determine the near/far objects in z-space. In particular, The z-space processor 630 serves to calculate the z_{flag} value of EQ. 2.

In some embodiments, the z-space processor 630 calculates the z_{flag} value of EQ. 2 for each feed from each 3D camera (e.g. 3D camera 501₁, 501₂, 501₃, 501₄, etc). Thus, the z-space processor 630 serves to provide at least one z_{flag} value for each 3D camera. The z_{flag} value may then be indicated by or near any of the candidate monitors 220 within a director's wall system 200 for producing a visual indication using a z-space flag indicator 216. And the indication may include any convenient representation of where the subject (focal point) is located in z-space; most particularly, indicating a z_{flag} value for each camera. Comparing the z_{flag} values then, the z-space processor 630 and/or the 3D realignment module 640 (or any other module, for that matter) might indicate the feeds as being in a positive cut zone (i.e. off screen—closer to the viewer than the screen plane), in a neutral cut zone (i.e. at the screen plane) or in a negative cut zone (i.e. behind the screen plane). By comparing the z-spaces corresponding to various feeds, the videographers, film editors, directors or other operators can make quick decisions for a comfortable 3D viewing experience.

In some cases, the operators might make quick decisions based on which cameras are in a positive cut zone and which are in a negative cut zone and, instead of feeding a particular 3D camera to the broadcast feed, the operators might request a camera operator to make a quick realignment.

In some embodiments, a z-space processing subsystem 610 may feature capabilities for overlaying graphic, including computer-generated 3D graphics over the image from the feed. It should further be recognized that a computer-generated 3D graphic will have a left view and a right view, and the geometric differences between the left view and the right view of the computer-generated 3D graphic are related to the z_{flag} value (and other parameters). Accordingly, a 3D graphics module 650 may receive and process the z_{flag} value, and/or pre-processed data, from any other modules that make use of the z_{flag} value. In some cases, a z-space processing subsystem 610 will process a signal and corresponding data in order to automatically align on-screen graphics with the z-space settings of a particular camera. Processing graphic overlays such that the overlays are generated to match the z-space characteristics of the camera serves to maintain the proper viewing experience for the audience.

Now it can be recognized that many additional features may be automated using the z-space settings of a particular camera. For example, if the z-space processing subsystem 610 flags a camera with an error code, the camera feed is automatically kicked offline for a correction by sending out either a single 2D feed (one camera) or a quick horizontal phase adjustment of the interaxial, or by the 3D engineer taking control of the 3D camera rig via a bi-directional remote control for convergence or interaxial adjustments from the engineering station to the camera rig.

### Correcting Z-Space Calculations for Camera Variations

As earlier mentioned, the estimate of the quantity z₀ (a distance) can be calculated with an accuracy proportional to the distance from the camera to the subject of interest. Stated differently, the estimate of the quantity z₀ will be less accurate when measuring to subjects that are closer to the camera as compared to the estimate of the quantity z₀ when measuring to subjects that are farther from the camera. In particular variations in lenses may introduce unwanted effects of curvatures or effects of blurring, which effects in turn may introduce calibration problems.

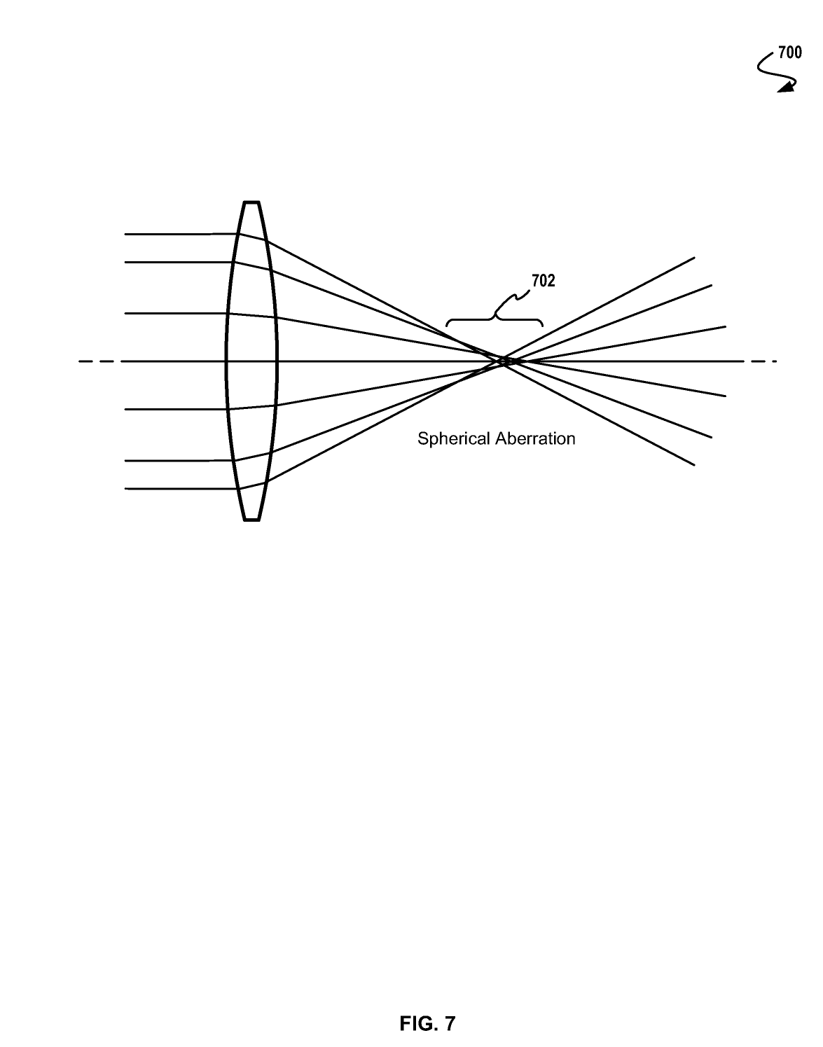

FIG. 7 depicts a schematic of a lens 700 having a ray aberration 702 that introduces different focal lengths depending on the incidence of the ray on the lens. In some cases, such aberrations may be modeled as a transformation, and the model transformation may be inverted, thus correcting for the aberration. Of course, the aberration shown in FIG. 7 is merely one of many aberrations produced by a lens when projecting onto a plane (e.g. onto a focal plane).

Some camera aberrations may be corrected or at least addressed using a camera aberration correction (e.g. a homographic transformation, discussed infra). As used herein, a homography is an invertible transformation from the real projective plane (e.g. the real-world image) to the projective plane (e.g. the focal plane) that maps straight lines (in the real-world image) to straight lines (in the focal plane). More formally, homography results from the comparison of a pair of perspective projections. A transformation model describes what happens to the perceived positions of observed objects when the point of view of the observer changes; thus, since each 3D camera is comprised of two 2D image sensors, it is natural to use a homography to correct certain aberrations. This has many practical applications within a system for flagging of z-space for a multi-camera 3D event. Once camera rotation and translation have been calibrated (or have been extracted from an estimated homography matrix), the estimated homography matrix may be used for correcting for lens aberrations, or to insert computer-generated 3D objects into an image or video, so that the 3D objects are rendered with the correct perspective and appear to have been part of the original scene.

### Transforming Z-Space Calculations for Camera Variations

Now, returning momentarily to the discussion of FIG. 3, and in particular the points P₁ and P₂. It should be recognized that points P₁ and P₂ are merely two points from among a large number of points of interest within the image capture in memory from an image sensor. Suppose there are two cameras a and b (e.g. a left view 2D camera 102, and a right view 2D camera 104), then, looking at points Pᵢ in a plane (for which a granularity of points is selected), a point ^{a}pᵢ can be calculated by passing the projections of Pᵢ from ^{b}Pᵢ in b to a point ^{a}Pᵢ in a:

^{a}pᵢ=Kₐ·H_{ba}·K_{b}⁻¹·^{b}pᵢ

where H_{ba} is

$${H}_{ba} = R - \frac{{tn}^{T}}{d}$$

The matrix R is the rotation matrix by which b is rotated in relation to a; t is the translation vector from a to b; and n and d are the normal vector of the plane and the distance to the plane, respectively. Kₐ and K_{b} are the cameras' intrinsic parameter matrices (which matrices might have been formed by a calibration procedure to correct camera aberrations).

The above homographic transformations may be used, for example, by a 3D graphics module 650 within a z-space processing subsystem 610 and, further, within a system for flagging of z-space for a multi-camera 3D event.

### Method for Flagging of Z-Space for a Multi-camera 3D Event

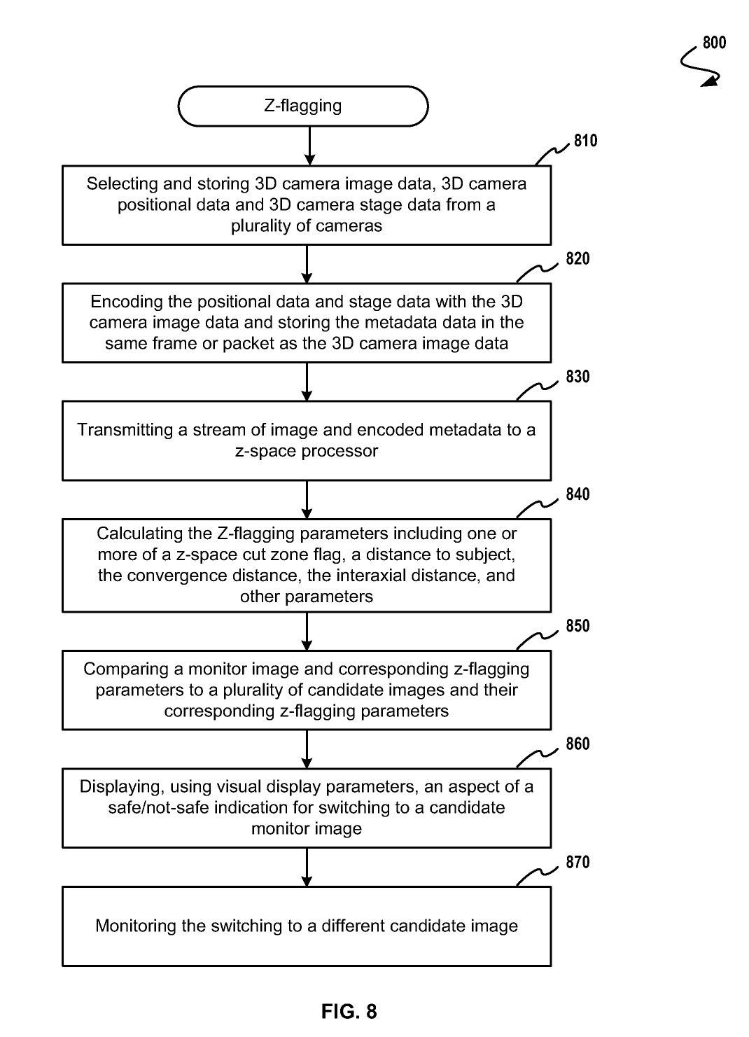

FIG. 8 depicts a flowchart of a method 800 for flagging of z-space for a multi-camera 3D event. Of course, the method 800 is an exemplary embodiment, and some or all (or none) of the operations mentioned in the discussion of method 800 might be carried out in any environment. As shown, a method for flagging of z-space for a multi-camera 3D event might be implemented using some of all of the operations of method 800, which method might commence by selecting 3D camera image data, 3D camera positional data, and 3D camera stage data from a plurality of cameras (e.g. 3D camera 501₁, 501₂, 501₃, 501₄, etc) in communication over a network, possibly over physical or virtual circuits including paths (see operation 810). Then, encoding the positional data and stage data (e.g. metadata) with the 3D camera image data, possibly storing the metadata data in the same frame or packet as the 3D camera image data (see operation 820) and transmitting a stream of image and encoded metadata to a z-space processor (see operation 830). Once the metadata is received in a z-space processor, the z-space processor might begin calculating the Z-flagging parameters including one or more of a z-space cut zone flag, the distance to subject, the convergence distance, the interaxial distance, and other parameters resulting from the metadata (see operation 840). The z-space processor (or any processor in the system for that matter) serves for comparing a monitor image (e.g. monitor 121) and its corresponding z-flagging parameters to a plurality of other sets of images and their corresponding z-flagging parameters; for example, the display could be to any plurality of the monitors within array 210 (see operation 850). Then, possibly using a director's wall system 200 or other display apparatus that serves for displaying, using visual display parameters (e.g. color, brightness, shading, on/off, etc) on or with any of the plurality of the monitors within array 210 an aspect of a safe/not-safe indication for switching to a different monitor image (see operation 860). At this point it is reasonable for creative people, such as videographers, film editors, directors, and the like to monitor the switching to a safe image for mastering or broadcast. In some situations, a z-space processor might serve for monitoring the switching to a different monitor image (see operation 870).

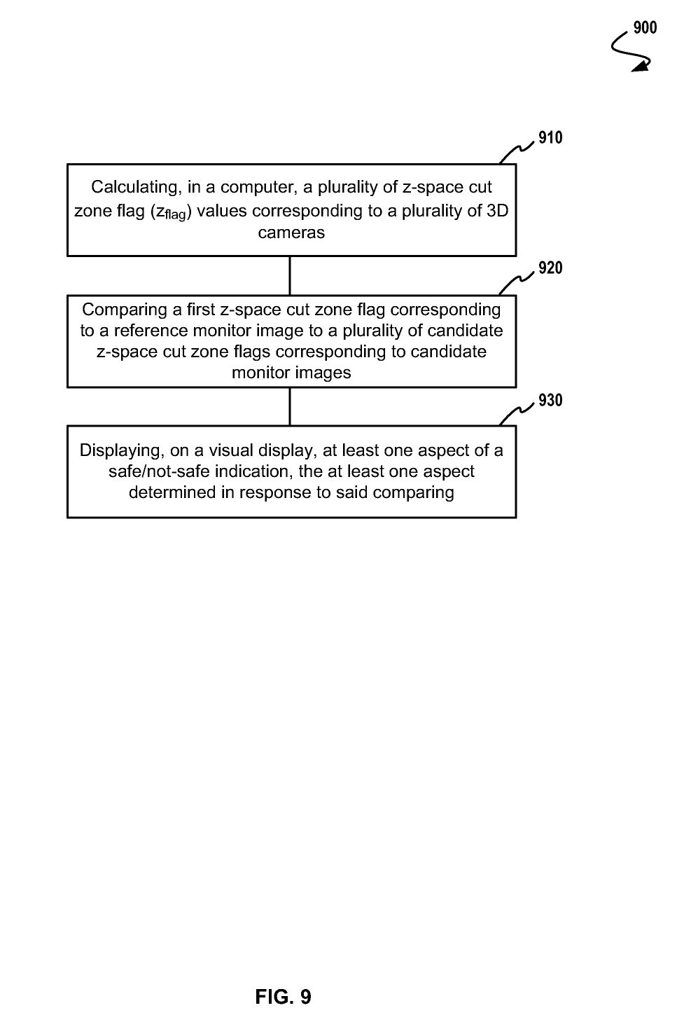

FIG. 9 depicts a flow chart of a method for selecting one from among a plurality of three-dimensional (3D) cameras. As an option, the present method 900 may be implemented in the context of the architecture and functionality of the embodiments described herein. Of course, however, the method 900 or any operation therein may be carried out in any desired environment. Any method steps performed within method 900 may be performed in any order unless as may be specified in the claims. As shown, method 900 implements a method for selecting one from among a plurality of three-dimensional (3D) cameras (e.g. 3D camera configuration 101), the method 900 comprising modules for: calculating, in a computer, a plurality of z-space cut zone flag (e.g. z_{flag}) values corresponding to the plurality of 3D cameras (see module 910); comparing a first z-space cut zone flag corresponding to the image of a reference monitor (e.g. reference monitor 230) to a plurality of candidate z-space cut zone flags corresponding to candidate monitor images (see module 920); and displaying, on a visual display (e.g. z-space flag indicator 216), at least one aspect of a safe/not-safe indication, the at least one aspect determined in response to the comparing (see module 930).

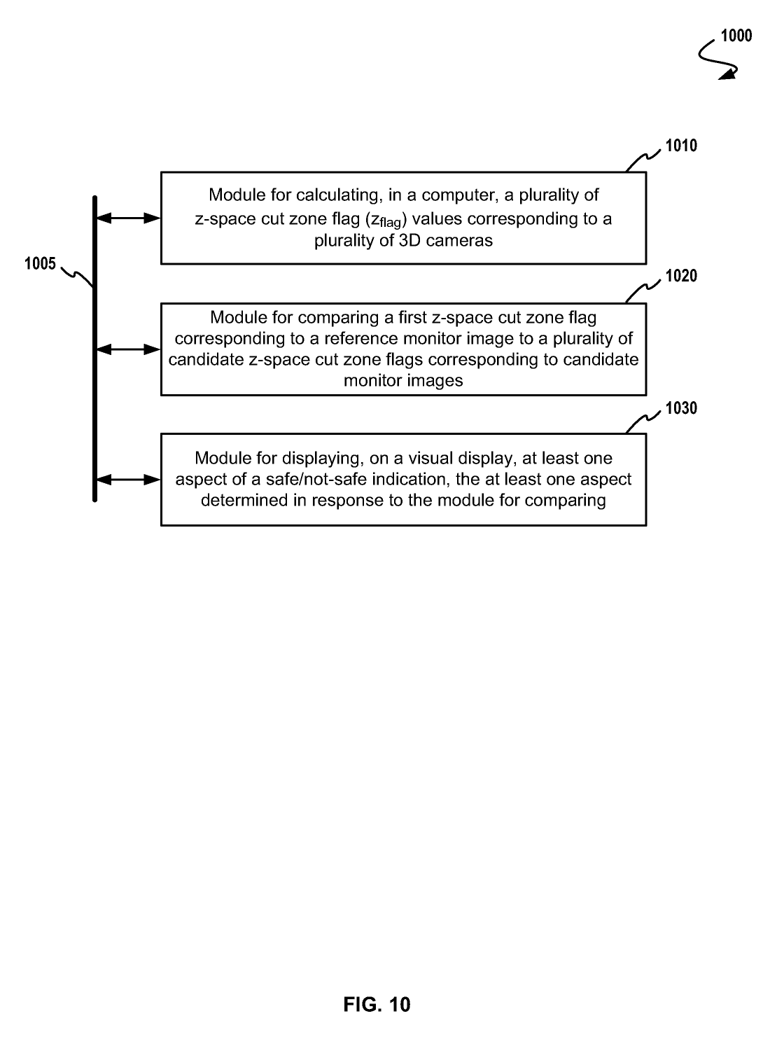

FIG. 10 depicts a block diagram of a system to perform certain functions of an apparatus for selecting one from among a plurality of three-dimensional (3D) cameras. As an option, the present system 1000 may be implemented in the context of the architecture and functionality of the embodiments described herein. Of course, however, the system 1000 or any operation therein may be carried out in any desired environment. As shown, system 1000 comprises a plurality of modules including a processor and a memory, each module connected to a communication link 1005, and any module can communicate with other modules over communication link 1005. The modules of the system can, individually or in combination, perform method steps within system 1000. Any method steps performed within system 1000 may be performed in any order unless as may be specified in the claims. As shown, FIG. 10 implements an apparatus as a system 1000, comprising modules including a module for calculating, in a computer, a plurality of z-space cut zone flag (z_{flag}) values corresponding to a plurality of 3D cameras (see module 1010); a module for comparing a z-space cut zone flag corresponding to a reference monitor image to a plurality of candidate z-space cut zone flags corresponding to candidate monitor images (see module 1020); and a module for displaying, on a visual display, at least one aspect of a safe/not-safe indication, the at least one aspect determined in response to the module for comparing (see module 1030).

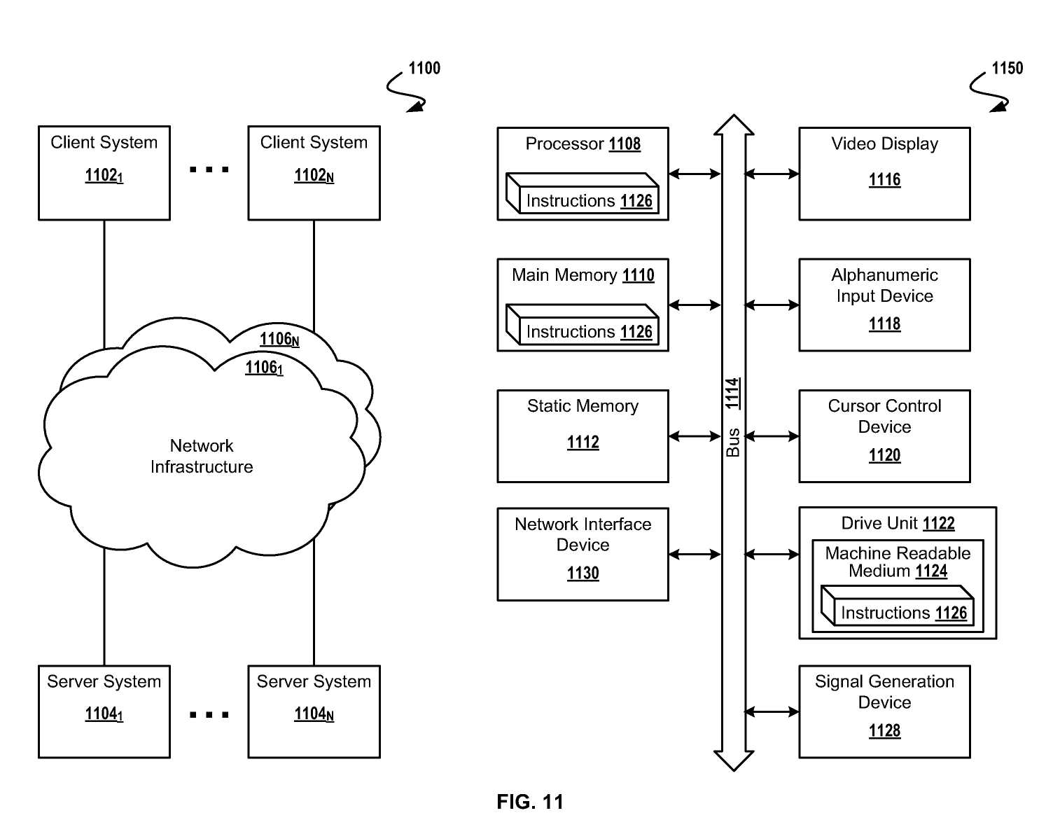

FIG. 11 is a diagrammatic representation of a network 1100, including nodes for client computer systems 1102₁ through 1102_{N}, nodes for server computer systems 1104₁ through 1104_{N}, nodes for network infrastructure 1106₁ through 1106_{N}, any of which nodes may comprise a machine 1150 within which a set of instructions for causing the machine to perform any one of the techniques discussed above may be executed. The embodiment shown is purely exemplary, and might be implemented in the context of one or more of the figures herein.

Any node of the network 1100 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1150 includes a processor 1108 (e.g. a processor core, a microprocessor, a computing device, etc), a main memory 1110 and a static memory 1112, which communicate with each other via a bus 1114. The machine 1150 may further include a display unit 1116 that may comprise a touch-screen, or a liquid crystal display (LCD), or a light emitting diode (LED) display, or a cathode ray tube (CRT). As shown, the computer system 1150 also includes a human input/output (I/O) device 1118 (e.g. a keyboard, an alphanumeric keypad, etc), a pointing device 1120 (e.g. a mouse, a touch screen, etc), a drive unit 1122 (e.g. a disk drive unit, a CD/DVD drive, a tangible computer readable removable media drive, an SSD storage device, etc), a signal generation device 1128 (e.g. a speaker, an audio output, etc), and a network interface device 1130 (e.g. an Ethernet interface, a wired network interface, a wireless network interface, a propagated signal interface, etc).

The drive unit 1122 includes a machine-readable medium 1124 on which is stored a set of instructions (i.e. software, firmware, middleware, etc) 1126 embodying any one, or all, of the methodologies described above. The set of instructions 1126 is also shown to reside, completely or at least partially, within the main memory 1110 and/or within the processor 1108. The set of instructions 1126 may further be transmitted or received via the network interface device 1130 over the network bus 1114.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method for selecting one from among a plurality of three-dimensional (3D) cameras comprising:
calculating, in a computer, a plurality of z-space cut zone flag (z_{flag}) values corresponding to the plurality of 3D cameras;
comparing a first z-space cut zone flag corresponding to a reference monitor image to a plurality of candidate z-space cut zone flags corresponding to candidate monitor images; and
displaying, on a visual display, at least one aspect of a safe/not-safe indication, the at least one aspect determined in response to said comparing.

2. The method of claim 1, further comprising:
storing, in a computer memory, at least one of, 3D camera image data, 3D camera positional data, 3D camera stage data;
encoding the 3D camera positional and 3D camera stage data with the 3D camera image data into an encoded data frame; and
transmitting, over a network, to a processor, a stream of encoded frame data.

3. The method of claim 1, wherein the calculating includes at least one of, 3D camera image data, 3D camera positional, 3D camera stage data.

4. The method of claim 1, wherein the calculating includes at least one of, interaxial data, convergence data, lens data.

5. The method of claim 1, wherein the comparing includes comparing the first z-space cut zone flag corresponding to a reference monitor image to at least one of a plurality of candidate z-space cut zone flags corresponding to candidate monitor images using a table of permitted transitions.

6. The method of claim 1, wherein the any one or more of the set of candidate monitor images are removed from the plurality of candidates in response to a corresponding 3D camera error code.

7. The method of claim 1, wherein the calculating includes a camera aberration correction.

8. An apparatus for selecting one from among a plurality of three-dimensional (3D) cameras comprising:
a module for calculating, in a computer, a plurality of z-space cut zone flag (z_{flag}) values corresponding to the plurality of 3D cameras;
a module for comparing a first z-space cut zone flag corresponding to a reference monitor image to a plurality of candidate z-space cut zone flags corresponding to candidate monitor images; and
a module for displaying, on a visual display, at least one aspect of a safe/not-safe indication, the at least one aspect determined in response to said comparing.

9. The apparatus of claim 8, further comprising:
a module for storing, in a computer memory, at least one of, 3D camera image data, 3D camera positional data, 3D camera stage data;
a module for encoding the 3D camera positional and 3D camera stage data with the 3D camera image data into an encoded data frame; and
a module for transmitting, over a network, to a processor, a stream of encoded frame data.

10. The apparatus of claim 8, wherein the calculating includes at least one of, 3D camera image data, 3D camera positional, 3D camera stage data.

11. The apparatus of claim 8, wherein the calculating includes at least one of, interaxial data, convergence data, lens data.

12. The apparatus of claim 8, wherein the comparing includes comparing the first z-space cut zone flag corresponding to a reference monitor image to at least one of a plurality of candidate z-space cut zone flags corresponding to candidate monitor images using a table of permitted transitions.

13. The apparatus of claim 8, wherein the any one or more of the set of candidate monitor images are removed from the plurality of candidates in response to a corresponding 3D camera error code.

14. The apparatus of claim 8, wherein the calculating includes a camera aberration correction.

15. A computer readable medium comprising a set of instructions which, when executed by a computer, cause the computer to select one from among a plurality of three-dimensional (3D) cameras, the set of instructions for:
calculating, in a computer, a plurality of z-space cut zone flag (z_{flag}) values corresponding to the plurality of 3D cameras;
comparing a first z-space cut zone flag corresponding to a reference monitor image to a plurality of candidate z-space cut zone flags corresponding to candidate monitor images; and
displaying, on a visual display, at least one aspect of a safe/not-safe indication, the at least one aspect determined in response to said comparing.

16. The computer readable medium of claim 15, further comprising:
storing, in a computer memory, at least one of, 3D camera image data, 3D camera positional data, 3D camera stage data;
encoding the 3D camera positional and 3D camera stage data with the 3D camera image data into an encoded data frame; and
transmitting, over a network, to a processor, a stream of encoded frame data.

17. The computer readable medium of claim 15, wherein the calculating includes at least one of, 3D camera image data, 3D camera positional, 3D camera stage data.

18. The computer readable medium of claim 15, wherein the calculating includes at least one of, interaxial data, convergence data, lens data.

19. The computer readable medium of claim 15, wherein the comparing includes comparing the first z-space cut zone flag corresponding to a reference monitor image to at least one of a plurality of candidate z-space cut zone flags corresponding to candidate monitor images using a table of permitted transitions.

20. The computer readable medium of claim 15, wherein the any one or more of the set of candidate monitor images are removed from the plurality of candidates in response to a corresponding 3D camera error code.

21. The computer readable medium of claim 15, wherein the calculating includes a camera aberration correction.
